(19) United States
(12) Patent Application Publication
(10) Pub. No.: US 2010/0011735 A1
(43) Pub. Date: Jan. 21, 2010

(54) DEFOLIATION DEVICE FOR BURIED PRODUCTS

(76) Inventor: Gilles-Alban Michaud, Argilly (FR)

Correspondence Address: HESLIN ROTHENBERG FARLEY & MESITI PC, 5 COLUMBIA CIRCLE, ALBANY, NY, 12203, US

(21) Appl. No.: 12/518,211

(22) PCT Filed: Dec. 8, 2006
(86) PCT No.: PCT/FR2006/051315

§ 371 Date: Jun. 29, 2009

(51) Int. Cl. A01D 23/02

(52) U.S. Cl. 56/121.4

(57) ABSTRACT

Device for defoliating buried products such as beets, comprises a rotor having, on part or all of its length, tools suitable for removing the leaves in particular by a rotation of the rotor. Each tool comprises at least one endless belt having arrangements for applying a striking force at the top of the product to cause the simultaneous cutting of the leaves in combination with a limited angular movement of the belt(s) at the time of the strike.

The invention relates to the technical field of agricultural equipment and relates more particularly to a device for defoliating buried products.

The invention has an advantageous application for defoliating beets, without excluding other buried products having leaves that must be removed before unearthing or simultaneously with the unearthing of the product concerned. Thus it has been found that the leaves of chicory delivered with the roots are detrimental to the satisfactory operation of the roasted chicory powder manufacturing industries and to the inulin manufacturing industries.

Various technical solutions have been proposed to strip buried products of their leaves. Thus one solution appears from the teaching of patent FR 2.787.965 which discloses a defoliation device comprising a rotor driven for example by the power takeoff of a tractor. The rotor accommodates cutting tools set at a certain height from the ground in order to perform the defoliation as such. In this embodiment, the tools consist of hammers forming a loop of which the free end is deformable in order to dampedly strike the crown of the beets for example, to cut the leaves. This solution has major advantages over the previously known solutions.

However, the result obtained is not entirely satisfactory because the design of the tools does not allow complete removal of the leaves of the buried beets or of any other plants. In particular, it now appears to be important to unearth the product and defoliate it simultaneously.

Based on this prior art, in particular that described in patent FR 2.787.965, the problem that the invention proposes to solve is to produce a device suitable for unearthing the product and for defoliating it, while settling the problem of the wear of the defoliation tools resulting from soil abrasion, but without destroying or damaging the crown of the products to be unearthed and to be defoliated.

To solve these various problems, according to the invention, each defoliation tool consists of at least one endless belt having arrangements for applying a striking force at the top of the product to cause the simultaneous cutting of the leaves in combination with a limited angular movement of the belt at the time of the strike.

To solve the problem of obtaining a simultaneous unearthing and defoliation, the arrangements for applying the striking force consist of blades joined, directly or added on, to part or all of the belt.

To solve the problem of detaching the crown or the top of the product, of removing the soil and consequently stripping all the leaves, each belt is mounted on a freely rotating cylindrical body.

To solve the problem of distributing the wear of the tools, the cylindrical body has coupling arrangements cooperating with the matching arrangements of the belts suitable for causing a limited translational movement of the belts under the striking force, resulting from a movement of the said body so as to present a new portion of the belt at the time of each strike.

This rotation of the body serves to shift the wear zone of each belt and consequently renew the contact zone consisting of the blades with the soil and the vegetables to be defoliated.

The cylindrical body is mounted in a support bearing joined to the rotor.

According to another feature, in view of the problem to be solved, at least one of the ends of the cylindrical body is subject to a free wheel system to drive it in only one direction and to block it in the other.

According to other features, the cylindrical body accommodates a plurality of juxtaposed belts.

The rotor is equipped with several sets of support bearings accommodating the belts which are optionally offset along the length of the said rotor.

The support bearings are disposed in pairs or more, and are aligned so that the belts are oriented substantially perpendicular to the drive axis of the rotor.

Advantageously, to solve the problem of the partial rotation of the cylindrical body at the time of the strike, the belts are made from a semi-rigid material with a limited elongation capacity under the effect of the centrifugal force resulting from the rotation of the rotor.

The invention is described in greater detail below in conjunction with the figures of the appended drawings in which:

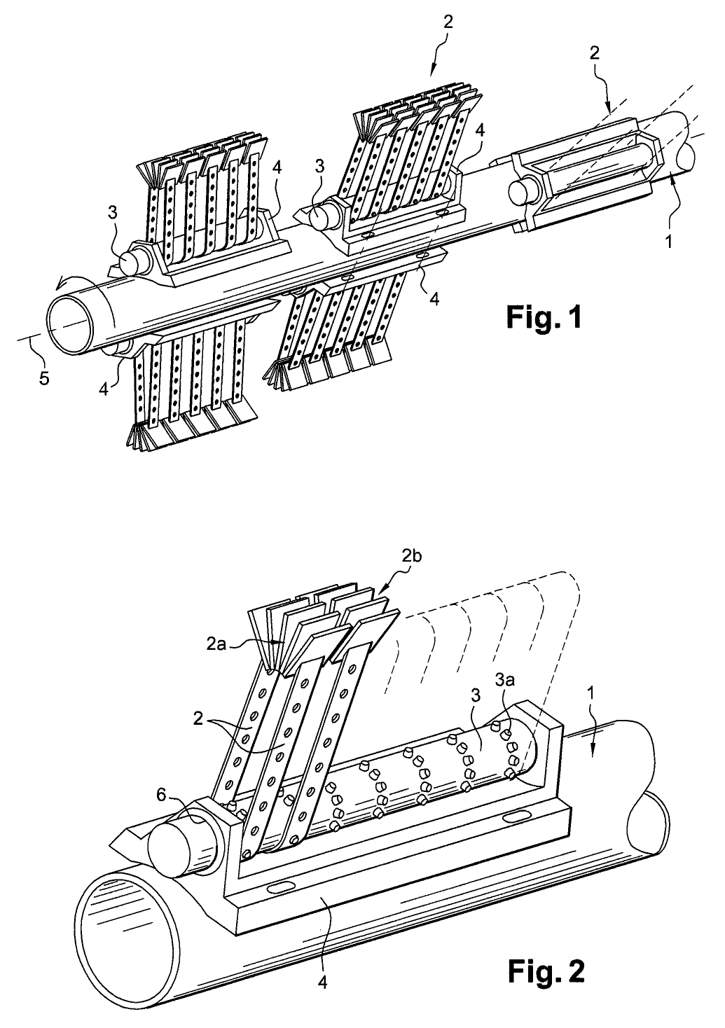

FIG. 1 is a perspective view of the rotor equipped with a plurality of support bearings for mounting the defoliation tools according to the invention in the form of belts;

FIG. 2 is a perspective view of one embodiment of a defoliation belt coupled to the cylindrical body;

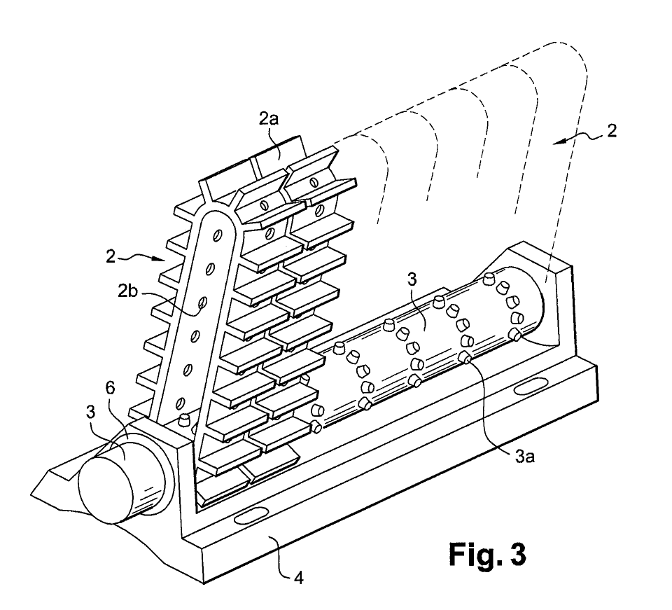

FIG. 3 is a view similar to FIG. 2 showing another embodiment of the defoliation belts;

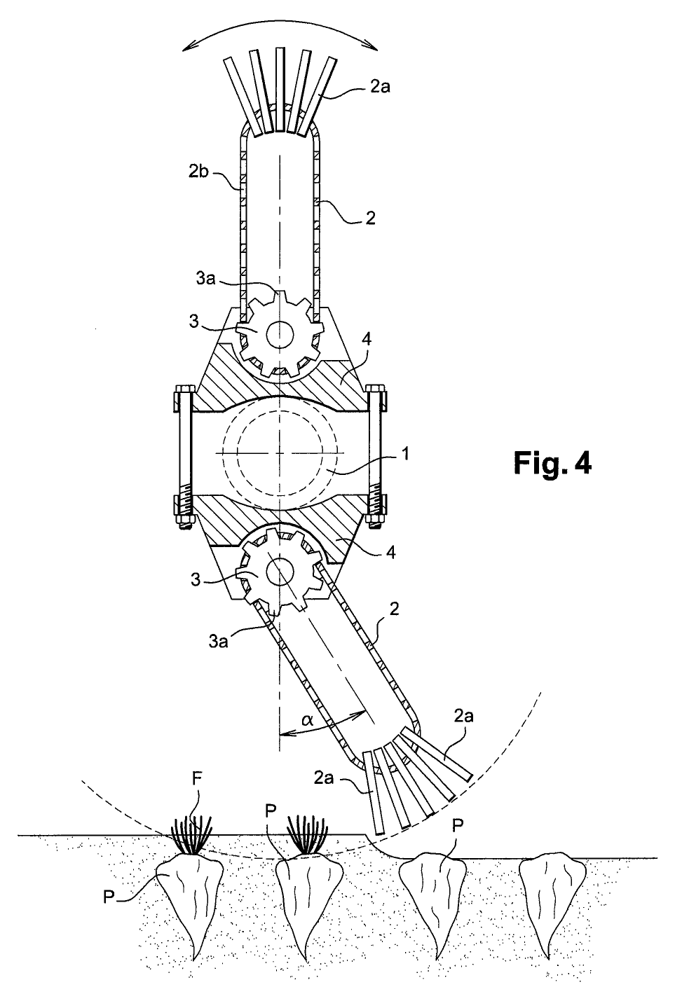

FIG. 4 shows a front cross-section showing the operating principle, and the principle of angular offset of the cylinder (3) equipped with its free wheel;

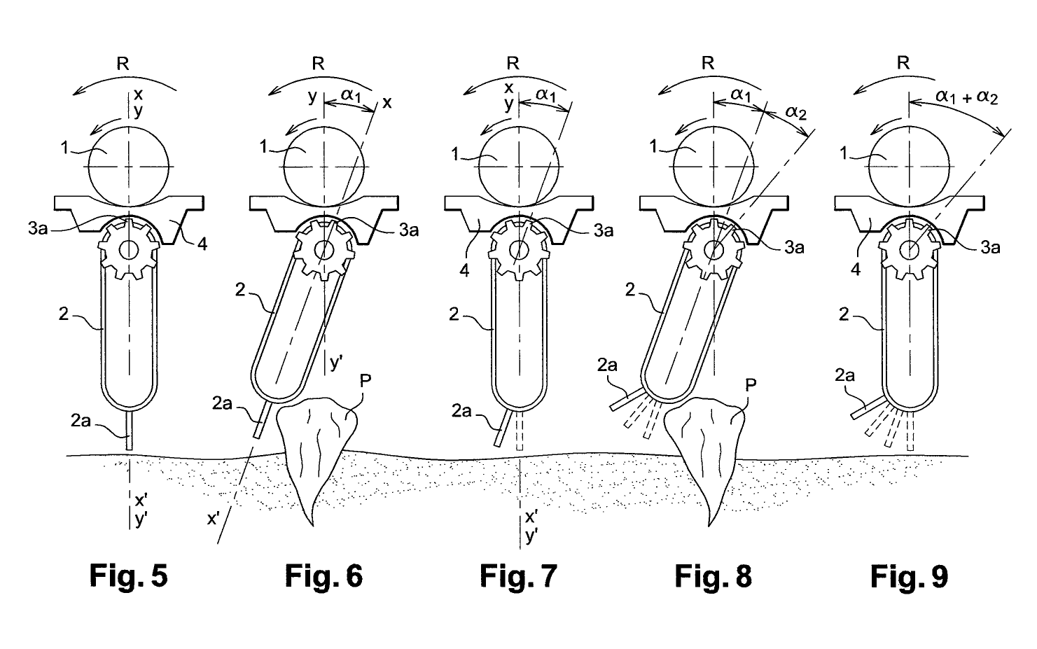

FIGS. 5 to 9 show the operating principle underlying the inventive device.

In a manner known per se, and as it appears from the teaching of patent FR 2.787.965, the defoliation device comprises rotor (1) having, on part of all of its length, tools (O) suitable for removing the leaves (F) of the buried products (P), such as beets, by the rotation of the said rotor (1). For this purpose, the rotor (1) can be coupled to the power takeoff of a tractor, either directly or via return elements. The rotor (1) assembly may be mounted on a frame equipped with ground travel means in order to constitute a drawn unit. The rotor (1) may conceivably be part of a self-contained motorized assembly.

According to the invention, each tool (O) consists of at least one endless belt (2) having arrangements (2a) for applying a striking force at the top of the product (P) to cause the simultaneous cutting of the leaves (F). The unearthing and defoliation of the products (P) take place, as indicated in the rest of the description, in combination with a limited angular movement of the belt (2) at the time of the strike.

The arrangements (2a) consist of blades joined, directly or added on, to part or all of the belt (2).

In FIG. 2, the blades (2a) consist of added elements sliding around the belt and being positioned at the end of the belt by the centrifugal force.

In FIG. 3, the blades (2a) are formed directly during the fabrication of the said belt and uniformly distributed along the entire length thereof.

According to an important feature of the invention, each belt (2) is mounted on a freely rotating cylindrical body (3). Advantageously, the cylindrical body (3) accommodates a plurality of juxtaposed belts. Furthermore, the cylindrical body (3) has coupling arrangements (3a) cooperating with matching arrangements (2b) of the belts in order to cause (as indicated in the rest of the description) the limited movement of the belt under the striking force. For example, the arrangements (3a) consist of a plurality of teeth arranged circularly and suitable for cooperating with the arrangements (2b) in the form of openings.

The cylindrical body (3), equipped with the various belts (2), is mounted in a support bearing (4) joined to the rotor (1). Advantageously, rotor (1) is equipped with several sets of support bearings (4) accommodating the belts (2) which are optionally offset along the length of the said rotor. Similarly, support bearings (4) are disposed in pairs, in threes or fours. The belts are oriented substantially perpendicular to the drive axis (5) of the rotor under the effect of the centrifugal force.

According to another important feature of the invention, at least one of the ends of the cylindrical body (3) is subject to a free wheel system (6) which the support bearing (4) has, to drive it in only one direction and to block it in the other.

It is also observed that the belts (2), regardless of their embodiment, are made from a semi-rigid material with a limited elastic elongation capacity under the effect of the centrifugal force resulting from the rotation of the rotor (1).

According to FIG. 4, the translational movement of the belts (2) causes the rotation of the cylindrical body (3)

This movement results from:
on the one hand, the centrifugal force generated by the rapid rotation of the rotor (1) supporting the various support bearings (4), this centrifugal force having the effect of tensioning the belts (2) along an axis passing substantially through the centre of the rotor;
on the other hand, the impact or the striking of the belts on the crown of the products or on the soil, which has the effect, for a fraction of a second, of causing an angular shift (α) of the belts, and consequently of the cylindrical body and of its free wheel in the free position in this case.

The tension belts (2) are mounted in the drive position with the cylindrical body (3) with an angular offset (α) to create a partial rotation of the said body (3) and the belts (2) at the time of impact. The free wheel (6) is also rotated in the same way as the cylindrical body (3).

It should be noted that at the time of mounting of the assembly, the free wheel (6) is in a free position at the time of the strike and not in a blocked position, thereby allowing the free drive of the cylindrical body (1) under the effect of the offset (α). When the belts (2) have cleared the product or the soil, under the effect of the rotation of the rotor (1), they then expand, so that their axis again passes through the axis of the said rotor (1). The cylindrical body (3) is rotated to accompany the belts (2) in an angular movement and is blocked in this position by their free wheel (6). The belts resume their angular position by winding around the cylindrical body blocked in rotation. Each strike thereby causes a movement of the belts allowing a shift of the wear zone of each belt and automatically renewing the contact surface on the soil and the vegetables to be defoliated.

Without falling beyond the scope of the invention, the free wheel (6) can be used in the reverse direction, so that the cylindrical body (3) is blocked under the effect of the angular offset (α). It is when the strike force is released that the belts are positioned along the axis passing through that of the rotor, driving the cylindrical body (1) and the free wheel.

Finally, in another embodiment, the two ends of the cylindrical body (3) can be equipped with an opposing free wheel system.

Reference can be made to FIGS. 5 to 9, which show the operating principle. To make it easier to understand the operation of the mechanism, a single assembly is shown consisting of a cylindrical body equipped with a single belt. This assembly is shown rotating (R) thanks to the rotor (1).

In FIG. 5, the assembly rotates and does not encounter any obstacle. The x-x′ axis of the belts merges with the y-y′ axis of the rotor (1). A single tooth (3a) of the cylindrical body (3) is shown, and also a single tooth (2a) of the belt (2). These two teeth (3a) and (2a) pass through the x-x′ axis or are parallel.

In FIG. 6, the belt encounters an obstacle and its x-x′ axis leaves the y-y′ axis of the rotor (1) forming an angle (α1) therewith. In this example, it is assumed that the cylindrical body equipped with its free wheel rotates freely at the desired moment. The tooth (3a) is offset by the same angle (α1). The belt passes the obstacle with this angle (α1).

In FIG. 7, after the obstacle, the belt resumes its initial position, as in FIG. 1. The x-x′ and y-y′ axes are merged again, but the cylindrical body cannot resume its initial position. The tooth (3a) remains offset by the angle (α1) by the free wheel blocked in this direction. The belt tooth (2a) is consequently also offset, and another tooth (dotted line) takes its place.

In FIG. 8, the belt again encounters an obstacle, its x-x′ axis leaves y-y′ of the rotor (1). The tooth (3a) is again offset by the value of the angle α2=x1+α2, and so on.

The advantages clearly appear from the description, in particular the following are emphasized and recalled:
the effectiveness of the result obtained limiting any risk of fouling liable to slow the rotation of the cylindrical body, under the effect of the combination of the tension and the angular offset of the belts;
the offset of the belts, at each strike movement, serves to distribute the wear;
the elimination of the shear effect caused by the impacts;
the efficiency of the defoliation of operation obtained;
the quality of the result obtained;
the mechanical simplicity allows the accurate rotation of the belts without mechanization or motorisation;
easy adaptation to any type of existing or new machine.

1. Device for defoliating buried products such as beets, comprising a rotor having, on part of all of its length, tools suitable for removing leaves in particular by rotation of said rotor, wherein each tool comprises at least one endless belt having arrangements for applying a striking force at a top of a product to cause simultaneous cutting of the leaves in combination with a limited angular movement of the belt or belts at time of strike.

2. Device according to claim 1, wherein the arrangements for applying the striking force comprise blades joined, directly or added on to all or part of the belt or belts.

3. Device according to claim 1, wherein each belt is mounted on a freely rotating cylindrical body.

4. Device according to claim 3, wherein the cylindrical body has coupling arrangements cooperating with matching arrangements of the belts for causing a limited translational movement of the belt or belts under the striking force, resulting from a movement of said body so as to present a new portion of the belt or belts at the time of each strike.

5. Device according to claim 3, wherein the cylindrical body is mounted in a support bearing joined to the rotor.

6. Device according to claim 3, wherein at least one end of the cylindrical body is subject to a free wheel system to drive the body in only one direction and to block movement in an opposite direction.

7. Device according to claim 3, wherein the cylindrical body accommodates a plurality of juxtaposed belts.

8. Device according to claim 7, wherein the rotor is equipped with several sets of support bearings accommodating the belts.

9. Device according to claim 8, wherein the support bearings are disposed in pairs or more, and are aligned so that the belts are oriented substantially perpendicular to a drive axis of the rotor under effect of centrifugal force.

10. Device according to claim 1, wherein the belt or belts are made from a semi-rigid material with a limited elongation capacity under effect of centrifugal force resulting from the rotation of the rotor.

11. Device according to claim 8, wherein the belts are offset along the length of the rotor.
